(19) United States
(12) Patent Application Publication
(10) Pub. No.: US 2026/0008169 A1
(43) Pub. Date: Jan. 8, 2026

(54) Power Tool

(71) Applicant: Robert Bosch GmbH, Stuttgart (DE)

(72) Inventors: Sebastian Reinhold, Aichwald (DE); Cornelius Boeck, Kirchheim (DE); Daniel Schaich, Altdorf (DE)

(21) Appl. No.: 19/256,771

(22) Filed: Jul. 1, 2025

(30) Foreign Application Priority Data
Jul. 5, 2024 (DE) 10 2024 206 375.4

(51) Int. Cl. B25F 5/02; B24B 47/12

(52) U.S. Cl. CPC B25F 5/02; B24B 47/12

(57) ABSTRACT

A power tool, in particular an angle grinder, is disclosed which has at least one switching unit which has at least one movably mounted switching pawl element, at least one guide element, in particular a cam guide element, for guiding the switching pawl element in a defined movement, and at least one releasing element pivotably mounted on the switching pawl element for unlocking a movement lock of the switching pawl element. The releasing element has at least one pivot axis extending at least essentially perpendicular to a main direction of movement of the switching pawl element and at least essentially perpendicular to a longitudinal extension direction of the switching pawl element.

This application claims priority under 35 U.S.C. § 119 to application no. DE 10 2024 206 375.4, filed on Jul. 5, 2024 in Germany, the disclosure of which is incorporated herein by reference in its entirety.

### BACKGROUND

A power tool, in particular an angle grinder, with at least one switching unit, which has at least one movably mounted switching pawl element, at least one guide element, in particular a cam guide element, for guiding the switching pawl element in a defined movement, and at least one releasing element pivotably mounted on the switching pawl element for unlocking a movement lock of the switching pawl element.

### SUMMARY

The disclosure relates to a power tool, in particular an angle grinder, with at least one switching unit, which has at least one movably mounted switching pawl element, at least one guide element, in particular a cam guide element, for guiding the switching pawl element in a defined movement, and at least one releasing element pivotably mounted on the switching pawl element for unlocking a movement lock of the switching pawl element.

It is proposed that the releasing element has at least one pivot axis which extends at least essentially perpendicular to a main direction of movement of the switching pawl element and at least essentially perpendicular to a longitudinal extension direction of the switching pawl element. Preferably, the releasing element is pivotably mounted directly on the switching pawl element and connected only via the switching pawl element to a handle housing and/or a switch housing. The defined movement of the switching pawl element is formed in particular by a combined movement. Preferably, the movement of the switching pawl element consists of at least one linear movement, in particular at least essentially parallel to the longitudinal extension direction of the switching pawl element, and a pivoting movement, in particular about a pivot axis, preferably on a cam track, which extends at least essentially perpendicular to a main direction of movement of the switching pawl element and at least essentially perpendicular to a longitudinal extension direction of the switching pawl element. Preferably, a pivot axis of the switching pawl element extends at least essentially parallel to the pivot axis of the releasing element. The movement of the switching pawl element and the movement of the releasing element together form a non-linear movement for an operator.

The power tool is preferably designed as a portable power tool, in particular as a portable, hand-held power tool. The term “portable power tool” is understood in this context to mean a power tool for machining workpieces and able to be transported by an operator without the need for a transport machine. The portable power tool has a mass that is less than 40 kg, preferably less than 10 kg, and particularly preferably less than 7 kg. The portable power tool is particularly preferred in the form of an angle grinder. However, it is also conceivable that the portable power tool has a different design that appears sensible to a person skilled in the art, such as a design as a drill and/or chisel hammer, as a drill, as a sabre saw, as a jigsaw, as hedge trimmers, etc. The term “switching unit” is used here in particular to define a unit that has at least one component, in particular the switching pawl element, which can be actuated directly by an operator and which is intended to influence and/or change a process and/or a state of a unit coupled to the switching unit by way of an actuation and/or by entering parameters. Preferably, the switching pawl element is movable and mounted around at least one axis of movement of the switching pawl element. The switching pawl element is preferably designed to actuate at least one switching element of the switching unit.

A “switching pawl element” here refers in particular to an operating element that has a longitudinal extension along a longitudinal extension direction of the operating element that is greater than a transverse extension of the operating element that runs at least essentially perpendicular to the longitudinal extension direction and at least essentially transverse to a direction of movement of the operating element. It is preferred that the maximum longitudinal extension of the switching pawl element is at least twice as large, preferably at least four times as large, and particularly preferably at least six times as large as the maximum transverse extension of the switching pawl element. The switching pawl element has a maximum longitudinal extension that is greater than 3 cm, preferably greater than 6 cm, and particularly preferably greater than 8 cm. Furthermore, the switching pawl element preferably comprises an operating surface on which an operator can place at least three fingers to actuate the switching pawl element and which has at least one longitudinal extension running along the longitudinal extension direction of the switching pawl element, which is greater than 5 cm. The term “essentially vertical” is used here in particular to define an orientation of a direction relative to a reference direction, wherein the direction and the reference direction, viewed in particular in a plane, form an angle of 90°, and the angle has a maximum deviation of in particular less than 8°, advantageously less than 5°, and particularly advantageously less than 2°. The switching unit is preferably designed to actuate the switching element by way of an actuation of the switching pawl element in order to open or close a circuit to a power supply for at least one drive unit of the power tool. The switching unit is therefore preferably designed to enable the power tool to be started up or deactivated. “Intended” should be understood to mean specifically designed and/or specially equipped. The switching element is preferably formed by a mechanical, electrical, and/or electronic switching element.

“Essentially transverse” is understood here to mean, in particular, an orientation of a direction and/or an axis relative to a reference direction and/or a reference axis, wherein the orientation of the direction and/or the axis is at least different from an orientation that is at least essentially parallel to the reference direction and/or the reference axis and, in particular, is skewed or perpendicular to the reference direction and/or the reference axis.

In this context, a “releasing element” refers in particular to an element such as a button, lever, bolt, or similar, which is designed to be actuated directly to unlock a movement lock of the switching pawl element. Preferably, the releasing element is designed to lock the switching pawl element directly or indirectly when it is not being actuated. The releasing element preferably implements the movement lock of the switching pawl element. The releasing element is preferably located directly on the switching pawl element and can be actuated with the same hand. To actuate, the releasing element must be pivoted, in particular around the pivot axis.

A “movement lock” should be understood here in particular as a locking mechanism which is designed to prevent, at least in one operating state, the movement of a movably mounted component along at least one path and/or around at least one axis by way of a mechanical, electrical, and/or electronic lock to the greatest extent possible. The movement lock is primarily intended to prevent movement of the movably mounted switching pawl element as far as possible, at least in one operating state, by way of a mechanical lock. However, it is also conceivable that the movement lock, at least in one operating state, largely prevents movement of the switching pawl element by way of an electromagnetic force and/or a permanent magnetic force, such as by way of displaceable magnets, acting on the switching pawl element. Preferably, the movement lock can be unlocked by the releasing element of the switching unit to allow movement of the switching pawl element as a result of actuation of the switching pawl element. The releasing element is preferably mounted so that it can pivot about the pivot axis of the releasing element in at least one direction in order to unlock the movement lock of the switching pawl element. Preferably, the switching unit comprises at least one spring element which acts on the releasing element with a spring force in the direction of a neutral position in which movement of the switching pawl element is largely prevented by the movement lock. The spring element is preferably designed as a torsion spring. However, another configuration of the spring element that would appear sensible to a person skilled in the art is also conceivable. It is particularly preferred that the pivot axis of the releasing element is arranged in at least one operating state, in particular in an operating state in which the operator's fingers are resting on the operating surface of the switching pawl element, at least essentially parallel to a joint axis of a finger of the operator, in particular at least essentially parallel to at least one joint axis of an index finger of the operator. “Essentially parallel” is to be understood here in particular to mean an orientation of a direction relative to a reference direction, in particular in a plane, wherein the direction has a deviation relative to the reference direction that is in particular less than 8°, advantageously less than 5° and particularly advantageously less than 2°. By designing the pivot axis of the releasing element as an axis that is different from an axis that is at least essentially perpendicular to the main direction of movement of the switching pawl element and at least essentially perpendicular to the longitudinal extension direction of the switching pawl element, it is possible to achieve ergonomic and comfortable operation of the releasing element. As a result of the pivotable mounting of the releasing element, which unlocks the movement lock of the switching pawl element in at least two different directions, in particular in at least two opposite directions, ergonomic operability of the releasing element for right-handed and left-handed users can be achieved in a particularly advantageous manner.

In this context, a “guide element” is understood to mean, in particular, an element which is intended to interact with the switching pawl element, in particular with a guide element of the switching pawl element, to cause the switching pawl element to move along a defined path. The guide element is preferably designed to guide the switching pawl element in a defined path when actuated, in particular so that the switching pawl element can only be moved in a defined path relative to the guide element. The guide element preferably forms a cam guide. Preferably, the guide element comprises a guide groove which describes a defined path and in which the guide element of the switching pawl element is guided. The guide element of the switching pawl element is positively guided on the guide element.

In this context, the “main direction of movement of the switching pawl element” refers in particular to the direction in which the switching pawl element is mainly moved when actuated. The main direction of movement is, in particular, at least essentially tangential to a pivot axis of the switching pawl element. Preferably, the main direction of movement is at least essentially perpendicular to the longitudinal extension direction of the switching pawl element. The longitudinal extension direction of the switching pawl element corresponds in particular to a main extension direction of the switching pawl element. A “main extension direction” of an object is understood to be a direction that runs parallel to the longest edge of a smallest geometric cuboid that just completely encloses the object. The expression “essentially perpendicular” is intended in particular to define an orientation of a direction relative to a reference direction, wherein the direction and the reference direction, in particular viewed in a projection plane, enclose an angle of 90° and the angle has a maximum deviation of in particular less than 8°, advantageously less than 5° and particularly advantageously less than 2°.

The design of the power tool according to the disclosure makes it possible, in particular, to provide a power tool that is advantageously safe and user-friendly. The switching unit design according to the disclosure makes it possible, in particular, to provide a switching unit that cannot be switched on with a linear movement. This in turn enables legal requirements, standards, and the like to be met in an advantageous manner.

It is also proposed that the guide element, in particular the cam guide element, provides at least one locking position, in particular an actuation locking position, for the switching pawl element. Preferably, the guide element has at least two guide sections, namely an actuation guide section and a locking guide section. In the actuation guide section, the switching pawl element is guided in particular along the main direction of movement of the switching pawl element. In the locking guide section, the switching pawl element is guided in particular at least essentially perpendicular to the main direction of movement and at least essentially parallel to the longitudinal extension direction of the switching pawl element. The locking guide section connects in particular to the actuation guide section. In particular, the switching pawl element can only be moved into the locking position after complete actuation and/or in an actuating position. The guide element is preferably designed to provide an L-shaped and/or J-shaped movement path for the switching pawl element. It is also proposed that the guide element, in particular the cam guide element, be designed to guide the switching pawl element in at least an approximately L-shaped manner. This makes it possible, in particular, to lock the switching pawl element, preferably after actuation. This in turn results in a high level of user comfort.

It is further proposed that the releasing element is formed by a spring-loaded lever and is designed to move automatically into a blocking position when not actuated. The releasing element is formed in particular by a spring-loaded pivot lever. The releasing element is preferably mounted so that it can pivot about the pivot axis of the releasing element in at least one direction in order to unlock the movement lock of the switching pawl element. Preferably, the switching unit comprises at least one spring element which acts on the releasing element with a spring force in the direction of a neutral position in which movement of the switching pawl element is largely prevented by way of the movement lock. The spring element is preferably designed as a torsion spring. This makes it possible, in particular, to provide an advantageous releasing element.

It is further proposed that the releasing element has an actuating section and a blocking section opposite the actuating section, which is designed in the blocking position to directly block movement of the switching pawl element. Preferably, a rotational axis of the releasing element is arranged between the actuating section and the blocking section. Preferably, the releasing element has an axle section which is arranged between the actuating section and the blocking section. Preferably, the actuating section is arranged first along a longitudinal extension of the releasing element, followed by the axle section and finally the blocking section. The actuating section forms a lever which is designed to be actuated directly by an operator to unlock a movement lock of the switching pawl element. The blocking section is specifically designed to interact with a blocking protrusion when the releasing element is in a blocking position.

Preferably, the blocking section is also formed by a blocking protrusion. The releasing element is preferably designed as a single piece, in particular integrally. The term “as a single piece” is to be understood in particular to mean at least a materially bonded connection, for example, by a welding process, an adhesive bonding process, an injection molding process and/or another process that appears to the person skilled in the art to be reasonable, and/or advantageously formed in one piece, for example, by production from a casting and/or by production in a single-component or multi-component injection molding method and advantageously from a single blank. Advantageously, “as a single piece” should also be understood as “integrally”. The term “integrally” should be understood in particular to mean to be formed as a single piece. Preferably, this single piece is manufactured from a single blank, a mass and/or a casting, particularly preferably in an injection molding method, especially a single and/or multi-component injection molding method. This makes it possible, in particular, to provide an advantageous releasing element. In particular, several functions can be implemented with the releasing element.

It is also proposed that the releasing element has at least one actuating position, wherein the actuating section in the actuating position is at least approximately flush with a grip surface of the switching pawl element. Preferably, the switching pawl element has a recess in which the releasing element is pivotably mounted. Depending on its position, the releasing element preferably protrudes beyond the grip surface of the switching pawl element or is at least approximately flush with a grip surface of the switching pawl element. Preferably, the releasing element has an actuating position and a blocking position in which the releasing element is in particular unactuated. In the blocking position, the releasing element protrudes beyond the grip surface of the switching pawl element, particularly with the actuating section. Preferably, a large part of the actuating section protrudes beyond the grip surface of the switching pawl element when the releasing element is in the blocking position. Preferably, a longitudinal extension direction of the releasing element in the blocking position extends at least essentially perpendicular to the longitudinal extension direction of the switching pawl element. Preferably, the longitudinal extension direction of the releasing element in the actuating position extends at least essentially parallel to the longitudinal extension direction of the switching pawl element. Preferably, the switching pawl element has an at least partially curved grip surface. The grip surface is curved, at least in the longitudinal extension direction of the switching pawl element. This enables particularly convenient operation. Preferably, the releasing element is received in the switching pawl element when the switching pawl element is actuated and is therefore not obstructive. In particular, it can be ensured that the releasing element does not protrude when the switching pawl element is actuated.

It is further proposed that the power tool has a switch housing on which the switching pawl element is movably mounted and which has at least one blocking protrusion which, in the blocking position of the releasing element, is designed to interact with the blocking section of the releasing element. The blocking protrusion is formed in particular by a dome protruding from a remainder of the housing unit, which has a contact surface for supporting the blocking section. The contact surface is preferably concave, with the curvature corresponding in particular to the radius of movement of the blocking section. Preferably, the blocking section abuts against the blocking protrusion to block the switching pawl element. The switch housing is used in particular to receive a switch and/or electronics of the switching unit. The switch housing forms part of a handle housing and/or is at least partially arranged in a handle housing. The handle housing is formed in particular by a shell housing. The term “handle housing” should be understood here to mean at least one housing or at least one partial region of the housing that is largely decoupled from a bearing of a drive and/or output unit of the power tool, wherein at least one grip region of the housing or the partial region of the housing, in particular a partial region of the housing that is designed as a stem-shaped grip region, can be grasped by an operator with at least one hand for handling the power tool. The term “largely accessible” refers here in particular to the accessibility of a component or component region by way of an operator's hand along at least more than 70%, preferably more than 80% and particularly preferably more than 90% of the total extension of the overall outer circumference of the component or component region extending in a plane at least essentially perpendicular to a longitudinal extension direction of the component or component region, wherein the total extension of the total circumference is in particular less than 40 cm, preferably less than 30 cm and particularly preferably less than 25 cm. Preferably, when the component or component region is grasped, the palm and finger inner surfaces of the operator's hand are located at least along a distance greater than 70%, preferably greater than 80% and particularly preferably greater than 90% of the total extension of the total outer circumference at the total outer circumference. It is preferable for the handle housing to be separate from a drive housing of the power tool, which is designed to receive the drive and/or output unit in order to support drive and/or output bearing forces. However, it is also conceivable that the handle housing and the drive housing are designed as a single piece. The handle housing preferably has a stem-shaped grip region which is inclined at an angle of at least less than 60°, preferably less than 40° and particularly preferably less than 30° relative to a main extension direction of the power tool. Preferably, the stem-shaped grip region is arranged behind the drive unit, viewed along a rotational axis of a drive element, in particular an armature shaft, a drive unit of the power tool, and in particular along the main extension direction of the power tool. In addition, it is conceivable that the handle housing has a bow-shaped partial region in addition to the stem-shaped grip region, which is molded as a single piece with the stem-shaped grip region. The bow-shaped partial region may preferably have an L-shaped design, extending in an L-shape from an end of the stem-shaped grip region facing away from the connection region of the handle housing towards the connection region. This makes it possible, in particular, to provide a switching unit that is safe and convenient to operate.

It is further proposed that the switching pawl element has at least one guide pin which is designed to interact with the at least one guide element, in particular a cam guide element, to guide the switching pawl element. Preferably, the guide pin of the switching pawl element is guided in a cam of the cam guide element. The guide pin forms part of the cam guide in particular. This enables, in particular, advantageous, reliable, and accurate guiding of the switching pawl element.

It is further proposed that the switching pawl element has at least one groove at an end of the switching pawl element facing away from the guide pin, which groove is provided for guiding the switching pawl element at least essentially parallel to a longitudinal extension direction of the switching pawl element. Preferably, the switch housing has a further guide pin on which the at least one groove of the switching pawl element is guided. The groove is used in particular to move the switching pawl element from an actuating position to a locking position. Preferably, when actuated, the switching pawl element is merely pivoted around the further guide pin, while the switching pawl element is guided linearly along the groove to a locking position. This enables, in particular, advantageous, reliable, and accurate guiding of the switching pawl element. In particular, it is possible to guide the switching pawl element in a defined, especially combined, movement.

Furthermore, the disclosure is based on a switching unit of the power tool.

The power tool according to the disclosure is not limited to the application and embodiment described above. In particular, the power tool according to the disclosure may have a number of individual elements, components, and units that differs from the number specified herein in order to perform the function described herein. Additionally, regarding the ranges of values indicated in this disclosure, values lying within the limits specified hereinabove are also provided to be considered as disclosed and usable as desired.

### BRIEF DESCRIPTION OF THE DRAWINGS

Further advantages follow from the description of the drawings below. An exemplary embodiment of the disclosure is shown in the drawing. The drawing, the description, and the claims contain numerous features in combination. A person skilled in the art will appropriately also consider the features individually and combine them into additional advantageous combinations.

The following is shown in the figures:

FIG. 1 a schematic representation of a power tool according to the disclosure with a switching unit.

FIG. 2 a partial section of the power tool according to the disclosure with the switching unit, which has a switching pawl element and a releasing element, in a blocking position, in a schematic sectional view.

FIG. 3 a partial section of the power tool according to the disclosure with the switching unit, which has the switching pawl element and the releasing element, in a releasing position, in a schematic sectional view.

FIG. 4 a partial section of the power tool according to the disclosure with the switching unit, which has the switching pawl element and the releasing element, in an actuating position, in a schematic sectional view, and

FIG. 5 a partial section of the power tool according to the disclosure with the switching unit, which has the switching pawl element and the releasing element, in a locking position, in a schematic sectional view.

### DETAILED DESCRIPTION

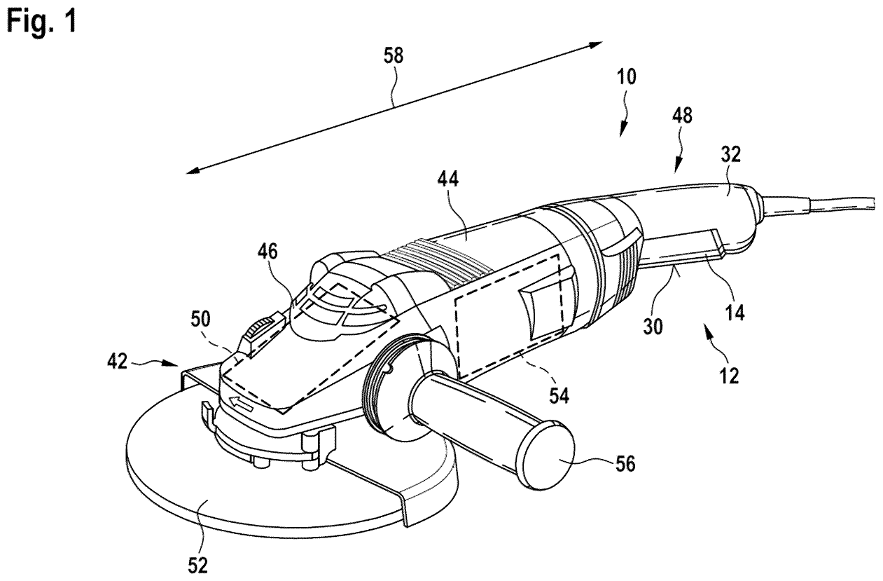

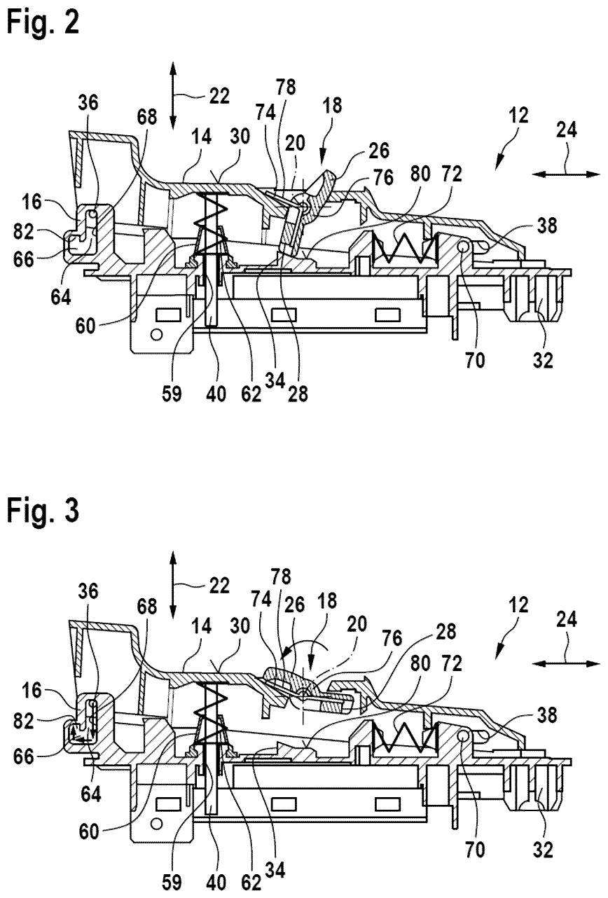

FIG. 1 shows a power tool 10 formed by a portable power tool 10 designed as an angle grinder. The portable power tool 10 has at least one switching unit 12, which comprises at least one movably mounted switching pawl element 14 for actuating at least one switching element 40 of the switching unit 12 (FIG. 2) and at least one releasing element 18 pivotably mounted on the switching pawl element 14 (FIG. 2) for unlocking a movement lock of the switching pawl element 14. The portable power tool 10 designed as an angle grinder further comprises a protective hood unit 42, a handle housing 84, a drive housing 44, and an output housing 46. A stem-shaped grip region 48 of the handle housing 84 forms a main handle of the portable power tool 10. The main handle extends at least essentially from a connection region of the handle housing 84 to the drive housing 44 in a direction away from the connection region to a side of the handle housing 84 on which a cable of the portable power tool 10 designed as an angle grinder is arranged for the supply of power. The stem-shaped grip region 48 of the handle housing 84 is inclined at an angle of less than 30° relative to a main extension direction 58 of the portable power tool 10.

An output shaft of an output unit 50 of the portable power tool 10 extends out of the output housing 46 in the form of a spindle (not shown in detail here), to which a machining tool 52 can be fixed for machining a workpiece (not shown in detail here). The machining tool 52 is designed as a grinding wheel. However, it is also conceivable that the machining tool 52 is designed as a cutting-off or polishing wheel. The portable power tool 10 comprises the drive housing 44 for receive a drive unit 54 of the portable power tool 10 and the output housing 46 for receive the output unit 50. The drive unit 54 is designed to drive the machining tool 52 in rotation via the output unit 50. The machining tool 52 can be connected to the spindle in a rotationally fixed manner by way of a fastening element (not shown in detail here) for machining a workpiece. This allows the machining tool 52 to be driven in a rotary manner during operation of the portable power tool 10. The output unit 50 is connected to the drive unit 54 in a manner already known to those skilled in the art via a drive element (not shown in detail here) of the drive unit 54, which is designed as a pinion and can be rotated. In addition, an additional handle 56 is arranged on the output housing 46. The additional handle 56 extends transversely to the main extension direction 58 of the portable power tool 10 when mounted on the output housing 46.

FIG. 2 shows a detailed view of the switching unit 12, which has the movably mounted switching pawl element 14 for actuating the switching element 40 and the releasing element 18, which is pivotably mounted on the switching pawl element 14, for unlocking a movement lock of the switching pawl element 14. The power tool 10 has a switch housing 32. The switch housing 32 forms part of the handle housing 84. The switch housing 32 is arranged in the handle housing 84. The switching element 40 is formed by an electrical switch. The switching element 40 serves to activate the drive unit 54. The switching element 40 is arranged in a mounted state in an inner region of the switch housing 32 in a receiving recess 59. The receiving recess 59 serves to guide the switching element 40. The switching element 40 comprises, in particular, a tappet for force transmission. A seal 60, in particular a rubber seal, is also arranged on the receiving recess 59, which is arranged around the switching element 40 and is intended to prevent dust from entering through the receiving recess 59. Furthermore, the switch housing 32 has a dome 86 extending in a ring around the receiving recess 59. The dome 86 and the seal 60 work together to receive the spring element 62 on one side. The first spring element 62 is formed by a coil spring.

The switching pawl element 14 is formed by an elongated switching pawl which extends along the main extension direction 58 of the power tool 10 over a large part of the handle, in particular the handle housing 84. The switching pawl element 14 is designed to be actuated when the handle housing 84 is gripped with several fingers, in particular with at least three, in particular four fingers. The switching pawl element 14 is pivotably mounted so that it can be displaced along a longitudinal axis.

The switching unit 12 has a guide element 16 for guiding the switching pawl element 14 in a defined movement. The guide element 16 is formed by a cam guide element. The guide element 16 provides a locking position, in particular an actuation locking position, for the switching pawl element 14. The guide element 16 has two guide sections, namely an actuation guide section 64 and a locking guide section 66. In the actuation guide section 64, the switching pawl element 14 is guided along a main direction of movement 22 of the switching pawl element 14. In the locking guide section 66, the switching pawl element 14 is guided at least essentially perpendicular to the main direction of movement 22 and at least essentially parallel to the longitudinal extension direction 24 of the switching pawl element 14. The locking guide section 66 connects to the actuation guide section 64. The switching pawl element 14 can only be moved into the locking position after it has been fully actuated and/or is in an actuating position. The guide element 16 is designed to guide the switching pawl element 14 in at least an approximately L-shaped manner. The guide element 16 has a guide groove 68 which describes a defined path and in which the switching pawl element 14 is guided. The guide groove 68 has the actuation guide section 64 and the locking guide section 66. The guide groove 68 has an L-shaped configuration. The switching pawl element 14 is positively guided on the guide element 16. The guide element 16 is designed as a single piece, in particular integrally, with the switch housing 32.

The switching pawl element 14 has a guide pin 36 which is designed to interact with the guide element 16 to guide the switching pawl element 14. The guide pin 36 of the switching pawl element 14 is guided in the guide groove 68 of the guide element 18. The guide pin 36 forms part of the cam guide. Furthermore, the switching pawl element 14 has a groove 38 at an end of the switching pawl element 14 facing away from the guide pin 36, which groove is provided for guiding the switching pawl element 14 at least essentially parallel to a longitudinal extension direction 24 of the switching pawl element 14. The switch housing 32 has a further guide pin 70, on which the groove 38 of the switching pawl element 14 is guided. The groove 38 serves to enable movement of the switching pawl element 14 from an actuating position to a locking position. When actuated, the switching pawl element 14 is merely pivoted about the further guide pin 70, wherein linear movement along the groove 38 is prevented by the guide element 16, while the switching pawl element 14 is guided linearly along the groove 38 to a locking position out of the actuating position.

The switching unit 12 further comprises two spring elements 62, 72, namely the first spring element 62 and a second spring element 72. The first spring element 62 is arranged in particular in a front region of the switching pawl element 14 in a region of the guide element 16. The first spring element 62 extends essentially parallel to the main direction of movement 22. The first spring element 62 has an effective direction parallel to the main direction of movement 22. The first spring element 62 is designed to move the switching pawl element 14 into an initial position, in particular into the blocking position. To actuate the switching pawl element 14, the switching pawl element 14 must be actuated against the spring force of the first spring element 62. The second spring element 72 is formed by a coil spring. The second spring element 72 is arranged in particular in a rear region of the switching pawl element 14 in a region of the groove 38. The second spring element 72 extends essentially parallel to the longitudinal extension direction 24. The second spring element 72 has an effective direction parallel to the longitudinal extension direction 24. The second spring element 72 is designed to move the switching pawl element 14 from the locking position, in particular the actuation locking position, into the actuating position. To displace the switching pawl element 14 from the actuating position to the locking position, the switching pawl element 14 must be moved against the spring force of the first spring element 62. The second spring element 72 is supported in a blocking position and in the actuating position of the switching unit 12 between two points of the switch housing 32. The switch housing 32 has two spaced-apart protrusions with fixing pins facing each other, on which the second spring element 72 is fixed with its opposite ends. The switching pawl element 14 has a drive protrusion in a region of the groove 38 which is not visible and is intended to drive an end of the spring element 72 facing the groove 38, in particular the rear end, when the switching pawl element 14 moves from the actuating position to the locking position. When the switching pawl element 14 moves from the locking position to the actuating position, the spring element 72 pushes the drive protrusion rearward until the spring element 72 rests again on the fixing pin of the switch housing 32.

Furthermore, the switching unit 12 has the releasing element 18. The releasing element 18 has a pivot axis 20 which extends at least essentially perpendicular to a main direction of movement 22 of the switching pawl element 14 and at least essentially perpendicular to a longitudinal extension direction 24 of the switching pawl element 14. The releasing element 18 is pivotably mounted directly on the switching pawl element 14 and is connected to a switch housing 32 solely via the switching pawl element 14. The releasing element 18 is formed by a spring-loaded lever and is designed to move automatically into a blocking position when not actuated. The releasing element 18 is formed by a spring-loaded pivot lever. The releasing element 18 is mounted so that it can pivot in one direction about the pivot axis 20 of the releasing element 18 in order to unlock the movement lock of the switching pawl element 14. The switching unit 12 comprises a further spring element 74, which acts on the releasing element 18 with a spring force in the direction of a neutral position, in which movement of the switching pawl element 14 is largely prevented by way of the movement lock. The further spring element 74 is designed as a torsion spring. The further spring element 74 is supported with one end on the switching pawl element 14 and with one end on the releasing element 18.

The releasing element 18 has an actuating section 26 and a blocking section 28 opposite the actuating section 26, which in the blocking position is designed to directly block movement of the switching pawl element 14. The pivot axis 20 of the releasing element 18 is located between the actuating section 26 and the blocking section 28. The releasing element 18 has an axle section 76 which is arranged between the actuating section 26 and the blocking section 28. Along the longitudinal extension of the releasing element 18, the actuating section 26 is arranged first, followed by the axle section 76 and finally the blocking section 28. The actuating section 26 forms a lever which is designed to be actuated directly by an operator to unlock a movement lock of the switching pawl element 14, in particular by tilting it. The blocking section 28 is designed to interact with a blocking protrusion 34 when the releasing element 18 is in a blocking position. Preferably, the blocking section 28 is also formed by a blocking protrusion. The releasing element 18 is designed as a single piece, in particular integrally. The releasing element 18 has an actuating position in which the switching pawl element 14 is released. In the actuating position, the actuating section 26 is at least approximately flush with a grip surface 30 of the switching pawl element 14 (FIG. 3).

The switching pawl element 14 has a recess 78 in which the releasing element 18 is pivotably mounted. Depending on its position, the releasing element 18 protrudes beyond the grip surface 30 of the switching pawl element 14 or is at least approximately flush with the grip surface 30 of the switching pawl element 14. The releasing element 18 has an actuating position (FIG. 3) and a blocking position (FIG. 2) in which the releasing element 18 is not actuated. In the blocking position, the releasing element 18 protrudes with the actuating section 26 beyond the grip surface 30 of the switching pawl element 14. A large part of the actuating section 26 protrudes beyond the grip surface 30 of the switching pawl element 14 when the releasing element 18 is in the blocking position. A longitudinal extension direction of the releasing element 18 extends in the blocking position at least essentially perpendicular to the longitudinal extension direction 24 of the switching pawl element 14. Furthermore, the longitudinal extension direction of the releasing element 18 in the actuating position extends at least essentially parallel to the longitudinal extension direction 24 of the switching pawl element 14.

Furthermore, the power tool 10 has the switch housing 32, on which the switching pawl element 14 is movably mounted. The switch housing 32 has a blocking protrusion 34 which, in the blocking position of the releasing element 18, is designed to interact with the blocking section 28 of the releasing element 18. The blocking protrusion 34 is formed by a dome protruding from a remainder of the switch housing 32, which has a contact surface 80 for supporting the blocking section 28. The contact surface 80 is concavely curved, with the curvature corresponding in particular to the radius of movement of the blocking section 28. The blocking section 28 rests against the blocking protrusion 34 to block the switching pawl element 14. To release, the blocking section 28 can be pivoted away from the blocking protrusion 34 by way of the actuating section 26.

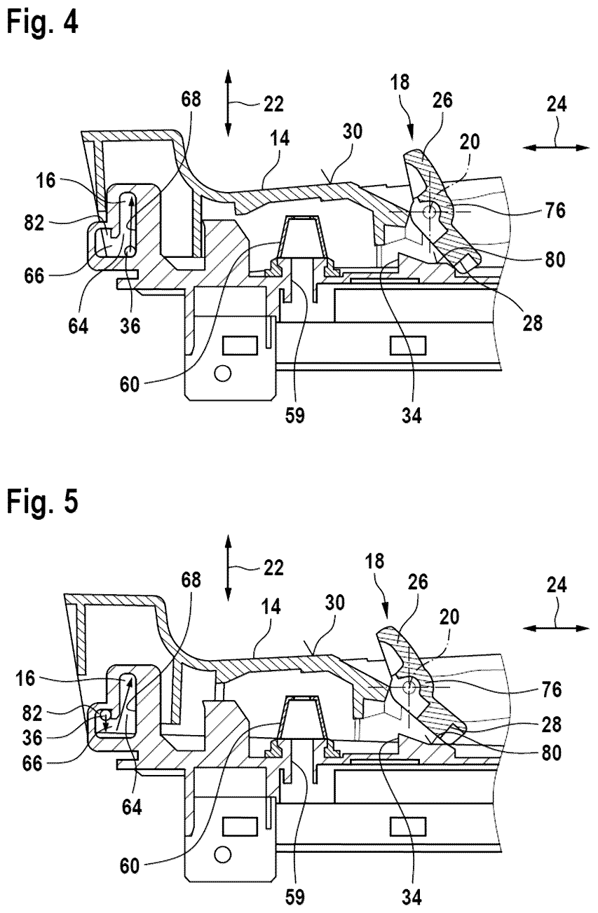

To switch on, the releasing element 18 must first be turned from the blocking position to the releasing position (FIG. 2). As soon as the releasing element 18 no longer rests against the blocking protrusion 34, the switching pawl element 14 can be pressed down by a guide along the actuation guide section 64 of the guide element 16 (FIG. 4). The switching pawl element 14 is pivoted around the additional guide pin 70. The simultaneous movement of the plunger of the switching element 40 switches on the power tool 10. When switching with a locking function, the switching pawl element 14 can finally be moved forward and upward into the so-called lock-on position by a guide along the locking guide section 66 of the guide element 16 (FIG. 5). The guide groove 68 has a bulge 82 in an end section of the locking guide section 66, in which the guide pin 36 can be fixed by the spring force of the first spring element 62.

When the switching unit 12 is locked, the switching pawl element 14 must be pressed downwards with the guide pin 36 out of the recess 82 in order to switch off. The spring elements 62, 72, 74, namely the first spring element 62, the second spring element 72, and the further spring element 74, automatically move the switching pawl element 14 and the releasing element 18 back to the starting position (FIG. 2). If the switching unit 12 is not locked or if the switch does not have a locking function, only the switching pawl element 14 must be released to switch off. The releasing element 18 does not impede the switch-off movement.

What is claimed is:

1. A power tool, comprising at least one switching unit, wherein:
the at least one switching unit includes (i) at least one movably mounted switching pawl element, (ii) at least one guide element configured to guide the switching pawl element in a defined movement, and (iii) at least one releasing element pivotably mounted on the switching pawl element and configured to unlock a movement lock of the switching pawl element, and
the releasing element has at least one pivot axis which extends at least essentially perpendicular to a main direction of movement of the switching pawl element and at least essentially perpendicular to a longitudinal extension direction of the switching pawl element.

2. The power tool according to claim 1, wherein the guide element provides at least one actuation locking position for the switching pawl element.

3. The power tool according to claim 1, wherein the guide element is designed to guide the switching pawl element in at least approximately an L-shape.

4. The power tool according to claim 1, wherein the releasing element is formed by a spring-loaded lever and is designed to move automatically into a blocking position when not actuated.

5. The power tool according to claim 4, wherein the releasing element has an actuating section and a blocking section opposite the actuating section, which in the blocking position is designed to directly block movement of the switching pawl element.

6. The power tool according to claim 5, wherein the releasing element has at least one actuating position, and wherein the actuating section in the actuating position is at least approximately flush with a grip surface of the switching pawl element.

7. The power tool according to claim 5, further comprising a switch housing on which the switching pawl element is movably mounted and which has at least one blocking protrusion which, in the blocking position of the releasing element, is designed to interact with the blocking section of the releasing element.

8. The power tool according to claim 1, wherein the switching pawl element has at least one guide pin which is designed to interact with the at least one guide element to guide the switching pawl element.

9. The power tool according to claim 7, wherein the switching pawl element has at least one groove at an end of the switching pawl element facing away from the guide pin, and wherein the groove is configured to guide the switching pawl element at least essentially parallel to a longitudinal extension direction of the switching pawl element.

10. A switching unit of a power tool according to claim 1.

11. The power tool according to claim 1, wherein the power tool is an angle grinder.

12. The power tool according to claim 1, wherein the at least one guide element is a cam guide element.
